(19) United States
(12) Patent Application Publication
(10) Pub. No.: US 2016/0291717 A1
(43) Pub. Date: Oct. 6, 2016

(54) MUTUAL CAPACITANCE MULTI-TOUCH CONTROL ELECTRODE STRUCTURE USING SINGLE LAYER METAL MESH

(71) Applicant: SHENZHEN CHINA STAR OPTOELECTRONICS TECHNOLOGY CO., LTD, Shenzhen, Guangdong (CN)

(72) Inventors: Ruhai FU, Shenzhen, Guangdong (CN); Yunglun LIN, Shenzhen, Guangdong (CN); Chunkai CHANG, Shenzhen, Guangdong (CN); Jie QIU, Shenzhen, Guangdong (CN); Chengliang YE, Shenzhen, Guangdong (US)

(21) Appl. No.: 14/390,384

(22) PCT Filed: Jul. 18, 2014
(86) PCT No.: PCT/CN2014/082531

§ 371 Date: Oct. 2, 2014

(30) Foreign Application Priority Data
Jul. 3, 2014 (CN) 201410315426.6

(51) Int. Cl. G06F 3/044; G06F 3/041

(52) U.S. Cl. CPC G06F 3/044; G06F 3/0416; G06F 2203/04104; G06F 2203/04112

(57) ABSTRACT

The present invention provides a mutual capacitance multi-touch control electrode structure using single layer metal mesh, comprises: a metal conducting mesh layer; the metal conducting mesh layer comprises a plurality of driving line areas a plurality of sensing line areas and a plurality of shielding line area; the driving line areas are located at one sides of the shielding line areas, and the sensing line areas are located at the other sides of the shielding line areas; the driving line area, sensing line area and shielding line area respectively comprise a plurality of mesh units, and in each of the areas, the mesh units are mutually electrically connected, and one mesh unit adjacent to another mesh unit in adjacent areas are mutually electrically connected; one mesh unit comprises a plurality of mesh edges and nodes formed by two adjacent and connected mesh edges. The present invention achieves the division of the driving line areas and the sensing line areas by subareas of the metal mesh lines and makes routing areas of the driving lines narrower by designing more compact metal mesh to narrow blind areas. Accordingly, the linearity fluctuation of the single layer mutual capacitance structure can be reduced.

### FIELD OF THE INVENTION

The present invention relates to a skill field of display, and more particularly to a mutual capacitance multi-touch control electrode structure using single layer metal mesh.

### BACKGROUND OF THE INVENTION

Compared with the single touch control panel, the multi-touch control panel which allows two points touch, multiple touch or even multi-person touch operations simultaneously is more convenient and more humanized. Recently, developed single layer multi-touch control panel not only possess merits of general multi-touch control panels but also take great advantage of the light and thin development of touch control electronic product because the thickness is smaller.

Please refer to FIG. 1, which is a structural diagram of a single multi-touch control panel using transparent conducting film according to prior art. As shown in FIG. 1, all the driving electrodes and the sensing electrodes of the traditional single layer multi-touch control panel demands one electrode wire 100 to be wired out of the visual area and all the wirings are from the same side. It leads to a larger occupied area of the electrode wires 100 in the visual area. Please refer to FIG. 2 in conjunction with FIG. 1. FIG. 2 is a partial structure 200 diagram of the single multi-touch control panel shown in FIG. 1. All the driving electrode wirings 101 in the traditional single layer touch panel are located in the same sides of the sensing electrode wires 102 for realizing the single layer multi-touch control function. Practically, the driving electrode wirings 101 cannot be very thin because the resistance of the Indium Tin Oxide (ITO) in the traditional single layer touch panel is larger. Therefore, the blind area cannot be narrow. In another word, the driving electrode wirings 101 occupy larger widths and lead to that the mutual capacitance blind areas appear and the continuity of touch control is interrupted. The area of the touch sensing active areas 201 is relatively smaller and the area of the touch sensing blind areas 202 relatively becomes increased. The existence of the touch sensing blind areas 202 can cause that a larger deviation happens to the weight calculation in the position calculation of the touch object. The reason is that when the touch object moves from one touch sensing unit to another touch sensing unit, the wider (larger) blind areas 202 makes that the touch object cannot immediately cover the other touch sensing unit. Therefore, a stable transition cannot be derived when the weight calculation is performed. As performing the position calculation, it will be biased toward the previous touch sensing unit.

Please refer to FIG. 3, which is a diagram showing the influence of the touch sensing blind area to the position calculation shown in FIG. 1. In the motion path 301 of the touch object, the traditional single layer touch control panel is capable of calculating more positions when the touch object is in the touch sensing active areas 201. However, the traditional single layer touch control panel can only calculate fewer positions when the touch object is in the touch sensing blind area 202. Consequently, the transition of the motion path 301 between the touch sensing active areas 201 and the touch sensing blind area 202 is not stable. Please refer to FIG. 4, which is a curve graph of the linearity deviation test corresponding to the diagonal shown in FIG. 3. The series 1 is the linearity deviation curve of the diagonal from the top left corner to the lower right corner of the single ITO (SITO) touch control panel, and the series 2 is the linearity deviation curve of the diagonal from the top right corner to the lower left corner of the single layer touch control panel. Obviously shown in FIG. 4, the linearity fluctuation of the traditional single layer touch control panel is larger.

At present, the conducting layer of the touch panel is formed on an isolative substrate mainly with Indium Tin Oxide compound by skills of vacuum coating and pattern etching. The requirements for the skill processes and equipments are higher and tons of Indium Tin Oxide compound is wasted and creates a large amount of industrial wastes including heavy metals; meanwhile, the metal (In) is a rare source which causes higher manufacture cost of the touch control panel. For efficiently reducing the cost of the touch control panel and satisfying the market trend of the light, thin consumer end electronic products, metal mesh touch panel (Metal Mesh TP) has been developed recently. The conducting layer of the sensing layer is to use a metal mesh as being the touch control electrodes to replace the Indium Tin Oxide compound and double layer structure is utilized. One layer is employed to be driving electrodes and the other layer is employed to be sensing electrodes. Mutual capacitances are formed between these two metal mesh layers. Please refer to FIG. 5a and FIG. 5b. FIG. 5a is a diagram of a rhombus metal mesh touch control electrode according to prior art. FIG. 5b is a diagram of a hexagon metal mesh touch control electrode according to prior art. The driving electrodes and the sensing electrodes of the double layer structure employed as being the touch control electrodes in the metal mesh touch screen can be rhombus metal mesh electrodes with same dimensions and sizes; alternately, the driving electrodes and the sensing electrode can all be the hexagon with same dimensions and sizes.

Please refer to FIG. 6a, which is a structural diagram of a metal mesh GFF (Glass-Film-Film) touch control panel using thin film material according to prior art. It comprises a cover glass 601, a metal mesh conducting film 602, a first touch control thin film layer 603 and a second touch control thin film layer 604. The touch screen of GFF structure merely comprises two conducting thin film layers. Tremendous improvements for the manufacture cost, the thickness, the weight can be achieved. However, too many uncontrollable factors result in that the yield of the product is low and the performance is baddish. The skill revolution of the GFF is GF. That is the previous two thin films for achieving touch control sensing are now reduced to be one layer. Basically, the design position of the sensing layer will be different and GF is further derived to be two solutions G1F and GF2. The G1F structure and GF2 structure reduce the two thin films for achieving touch control sensing to be one layer and the thickness is thinner. Please refer to FIG. 6b, which is a structural diagram of a metal mesh GF2 touch control panel using thin film material according to prior art. It comprises a cover glass 601, a metal mesh conducting film 602, and a touch control thin film layer 605. As shown in FIG. 6a and FIG. 6b, the touch control structure of the metal mesh GF2 is lighter and thinner than the touch control structure of the metal mesh GFF, which is beneficial to reduce the manufacture cost and capable of accomplishing a touch screen having a narrow frame.

### SUMMARY OF THE INVENTION

An objective of the present invention is to provide a mutual capacitance multi-touch control electrode structure using single layer metal mesh capable of narrowing blind areas to reduce the linearity fluctuation of the single layer mutual capacitance structure.

For realizing the aforesaid objective, the present invention provides a mutual capacitance multi-touch control electrode structure using single layer metal mesh, comprising: a metal conducting mesh layer; the metal conducting mesh layer comprises a plurality of driving line areas, a plurality of sensing line areas and a plurality of shielding line area; the driving line areas are located at one sides of the shielding line areas, and the sensing line areas are located at the other sides of the shielding line areas; the driving line area, sensing line area and shielding line area respectively comprise a plurality of mesh units, and in each of the areas, the mesh units are mutually electrically connected, and one mesh unit adjacent to another mesh unit in adjacent areas are mutually electrically connected; one mesh unit comprises a plurality of mesh edges and nodes formed by two adjacent and connected mesh edges.

The driving line area comprises: a plurality of first driving electrodes and a plurality of second driving electrodes, and the first driving electrode comprises a plurality of first driving lines, and the second driving electrode comprises a plurality of second driving lines; the sensing line area comprises a plurality of sensing electrodes, and the sensing electrode comprises a plurality of sensing lines; the shielding line area comprises a plurality of shielding lines.

Each of the first driving lines, the second driving lines, the sensing lines and the shielding lines is a group consisting of several mesh edges.

The electrical isolations among the first driving lines, the second driving lines, the sensing lines and the shielding lines are achieved by micro disconnections among the mesh edges.

The distances among the first driving lines, the second driving lines, the sensing lines and the shielding lines which are adjacent are smaller than 100 μm to provide enough meshes for dividing the driving line areas and the sensing line areas and forming the mutual capacitances.

The mutual capacitances are formed between the first driving electrodes and the sensing electrodes.

The mutual capacitances are achieved by comb structures between the first driving electrodes and the sensing electrodes.

An appearance of each of the mesh units is a rhombus.

A thickness of the metal conducting mesh layer is in a scale of 0.1 μm.

The benefits of the present invention are: the present invention provides a mutual capacitance multi-touch control electrode structure using single layer metal mesh. By uniform mesh routing to achieve the consistency of the whole light transmittance of the touch screen and division of the driving line areas and the sensing line areas by subareas of the metal mesh lines. With the more compact metal mesh designed according to the present invention, the routing areas of the driving lines can be made narrower to narrow the blind areas. Accordingly, the linearity fluctuation of the single layer mutual capacitance structure can be reduced.

In order to better understand the characteristics and technical aspect of the invention, please refer to the following detailed description of the present invention is concerned with the diagrams, however, provide reference to the accompanying drawings and description only and is not intended to be limiting of the invention.

### BRIEF DESCRIPTION OF THE DRAWINGS

The technical solution, as well as beneficial advantages, of the present invention will be apparent from the following detailed description of an embodiment of the present invention, with reference to the attached drawings.

In drawings,

FIG. 1 is a structural diagram of a single multi-touch control panel using transparent conducting film according to prior art;

FIG. 2 is a partial structure diagram of the single multi-touch control panel shown in FIG. 1;

FIG. 3 is a diagram showing the influence of the touch sensing blind area to the position calculation shown in FIG. 1;

FIG. 4 is a curve graph of the linearity deviation test corresponding to the diagonal shown in FIG. 3;

FIG. 5a is a diagram of a rhombus metal mesh touch control electrode according to prior art;

FIG. 5b is a diagram of a hexagon metal mesh touch control electrode according to prior art;

FIG. 6a is a structural diagram of a metal mesh GFF touch control panel using thin film material according to prior art;

FIG. 6b is a structural diagram of a metal mesh GF2 touch control panel using thin film material according to prior art;

FIG. 7 is a subarea diagram of a mutual capacitance multi-touch control electrode structure using single layer metal mesh according to the present invention;

FIG. 8 is a comparison diagram of linearity fluctuations of the present invention and the single layer ITO skill.

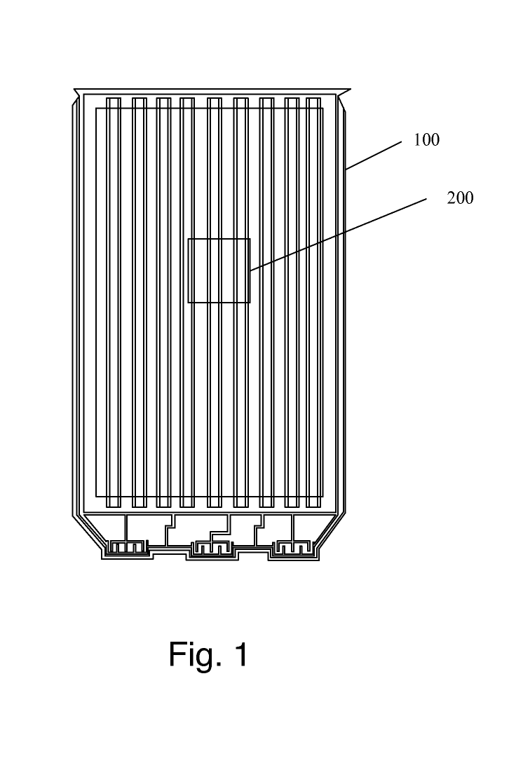

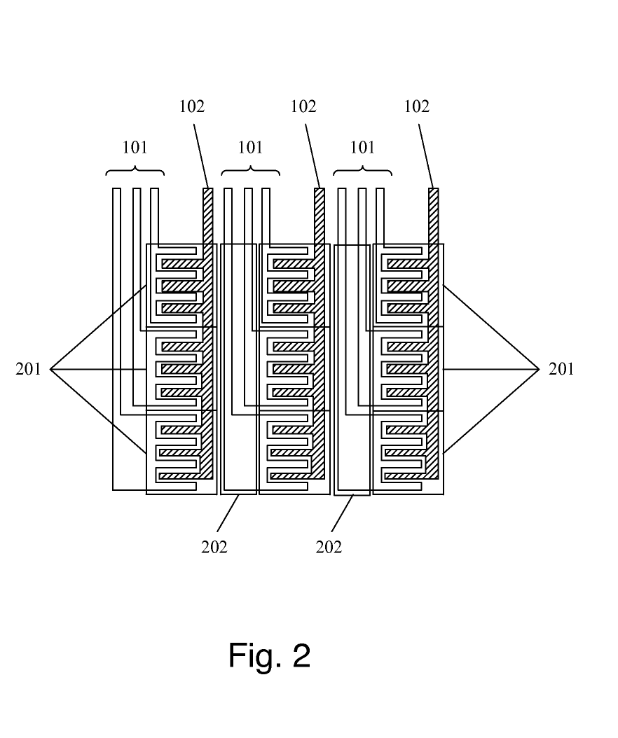

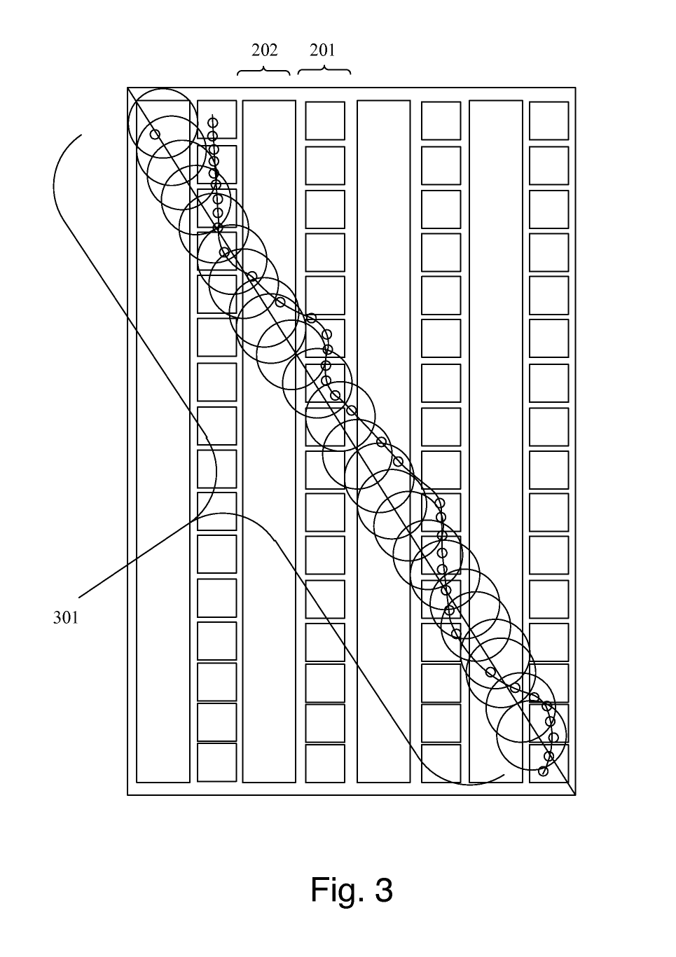

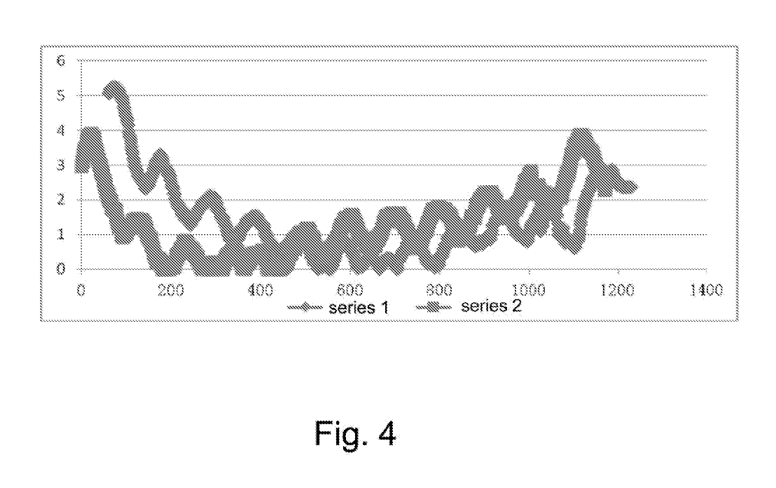

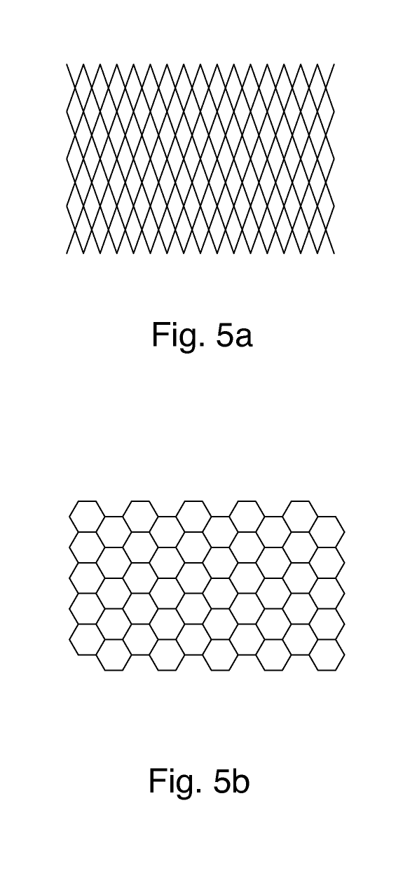

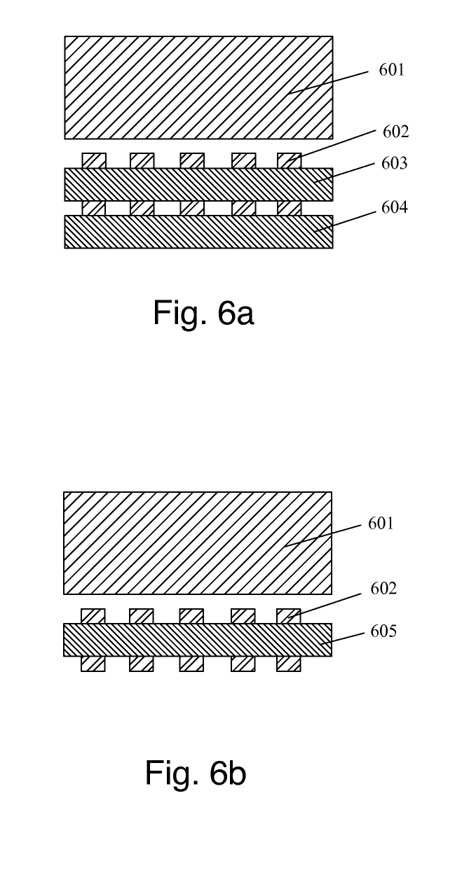

### DETAILED DESCRIPTION OF PREFERRED EMBODIMENTS

Embodiments of the present invention are described in detail with the technical matters, structural features, achieved objects, and effects with reference to the accompanying drawings as follows.

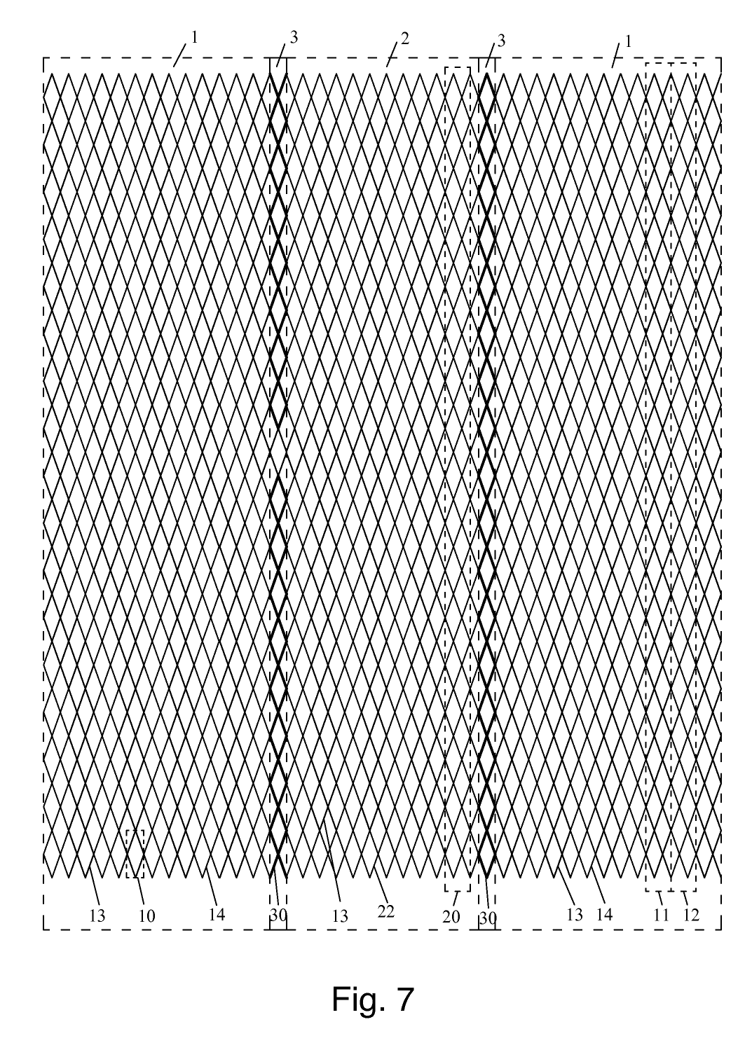

Please refer to FIG. 7, which is a subarea diagram of a mutual capacitance multi-touch control electrode structure using single layer metal mesh according to the present invention, comprising: a metal conducting mesh layer; the metal conducting mesh layer comprises a plurality of driving line areas 1, a plurality of sensing line areas 2 and a plurality of shielding line area 3; the driving line areas 1 are located at one sides of the shielding line areas 3, and the sensing line areas 2 are located at the other sides of the shielding line areas 3; the driving line area 1, sensing line area 2 and shielding line area 3 respectively comprise a plurality of mesh units 10, and in each of the areas, the mesh units 10 are mutually electrically connected, and one mesh unit 10 adjacent to another mesh unit 10 in adjacent areas are mutually electrically connected; one mesh unit 10 comprises a plurality of mesh edges and nodes formed by two adjacent and connected mesh edges;

the driving line area 1 comprises: a plurality of first driving electrodes 11 and a plurality of second driving electrodes 12, and the first driving electrode 11 comprises a plurality of first driving lines 13, and the second driving electrode 12 comprises a plurality of second driving lines 14; the sensing line area 2 comprises a plurality of sensing electrodes 20, and the sensing electrode 20 comprises a plurality of sensing lines 22; the shielding line area 3 comprises a plurality of shielding lines 30; each of the first driving lines 13, the second driving lines 14, the sensing lines 22 and the shielding lines 30 is a group consisting of several mesh edges; the electrical isolations among the first driving lines 13, the second driving lines 14, the sensing lines 22 and the shielding lines 30 are achieved by micro disconnections among the mesh edges.

In this embodiment, an appearance of each of the mesh units 10 is a rhombus. Other appearances, such as oblong, triangle, hexagon or etc. also can be employed for the mesh units;

in the metal conducting mesh layer, the distances among the first driving lines 13, the second driving lines 14, the sensing lines 22 and the shielding lines 39 which are adjacent have to be smaller (smaller than 100 μm) to provide enough meshes for dividing the driving line areas and the sensing line areas and forming the mutual capacitances.

The mutual capacitances are formed between the first driving electrodes 11 and the sensing electrodes 20.

A thickness of the metal conducting mesh layer is merely required in a scale of 0.1 μm. The enough mutual capacitances between the first driving electrodes 11 and the sensing electrodes 20 can be achieved by a large number of the comb structures because pitches among the adjacent first driving lines 13, the second driving lines 14, the sensing lines 22 and the shielding lines 30 of the metal conducting mesh layer are small. Therefore, the thickness increase of the metal conducting mesh layer is not required for enlarging the mutual capacitances.

Smaller sensor pitch can be achieved as long as the metal mesh lines are concentrated enough. Meanwhile the blind areas can be narrower.

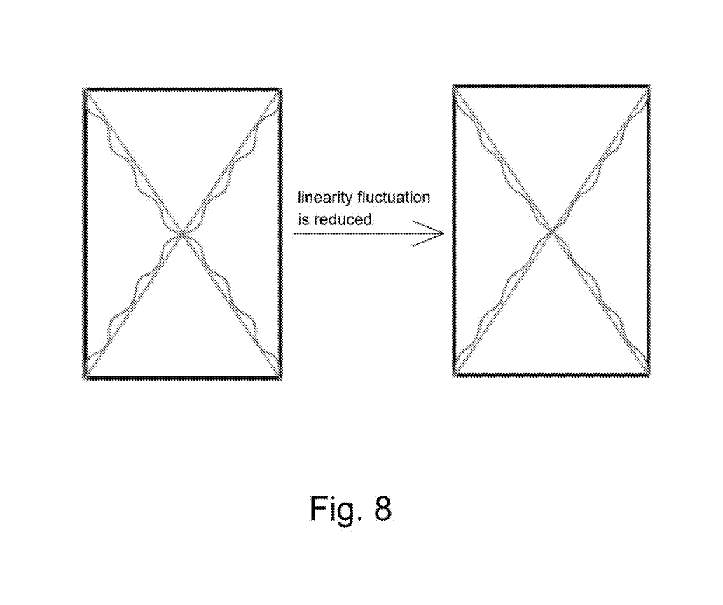

Please refer to FIG. 8, which is a comparison diagram of linearity fluctuations of the present invention and single layer ITO skill. The left side of FIG. 8 is the linearity fluctuation diagram of the single layer ITO skill. The right side of FIG. 8 is the linearity fluctuation diagram of the present invention. As shown in FIG. 8, the mutual capacitance multi-touch control electrode structure using single layer metal mesh according to the present invention is capable of effectively reducing the linearity fluctuation.

In conclusion, the present invention provides a mutual capacitance multi-touch control electrode structure using single layer metal mesh. By uniform mesh routing to achieve the consistency of the whole light transmittance of the touch screen and division of the driving line areas and the sensing line areas by subareas of the metal mesh lines. With the more compact metal mesh designed according to the present invention, the routing areas of the driving lines can be made narrower to narrow the blind areas. Accordingly, the linearity fluctuation of the single layer mutual capacitance structure can be reduced.

Above are only specific embodiments of the present invention, the scope of the present invention is not limited to this, and to any persons who are skilled in the art, change or replacement which is easily derived should be covered by the protected scope of the invention. Thus, the protected scope of the invention should go by the subject claims.

What is claimed is:

1. A mutual capacitance multi-touch control electrode structure using single layer metal mesh, comprising: a metal conducting mesh layer; the metal conducting mesh layer comprises a plurality of driving line areas, a plurality of sensing line areas and a plurality of shielding line area; the driving line areas are located at one sides of the shielding line areas, and the sensing line areas are located at the other sides of the shielding line areas; the driving line area, sensing line area and shielding line area respectively comprise a plurality of mesh units, and in each of the areas, the mesh units are mutually electrically connected, and one mesh unit adjacent to another mesh unit in adjacent areas are mutually electrically connected; one mesh unit comprises a plurality of mesh edges and nodes formed by two adjacent and connected mesh edges.

2. The mutual capacitance multi-touch control electrode structure using single layer metal mesh according to claim 1, wherein the driving line area comprises: a plurality of first driving electrodes and a plurality of second driving electrodes, and the first driving electrode comprises a plurality of first driving lines, and the second driving electrode comprises a plurality of second driving lines; the sensing line area comprises a plurality of sensing electrodes, and the sensing electrode comprises a plurality of sensing lines; the shielding line area comprises a plurality of shielding lines.

3. The mutual capacitance multi-touch control electrode structure using single layer metal mesh according to claim 2, wherein each of the first driving lines, the second driving lines, the sensing lines and the shielding lines is a group consisting of several mesh edges.

4. The mutual capacitance multi-touch control electrode structure using single layer metal mesh according to claim 3, wherein electrical isolations among the first driving lines, the second driving lines, the sensing lines and the shielding lines are achieved by micro disconnections among the mesh edges.

5. The mutual capacitance multi-touch control electrode structure using single layer metal mesh according to claim 4, wherein distances among the first driving lines, the second driving lines, the sensing lines and the shielding lines which are adjacent are smaller than 100 μm to provide enough meshes for dividing the driving line areas and the sensing line areas and forming the mutual capacitances.

6. The mutual capacitance multi-touch control electrode structure using single layer metal mesh according to claim 1, wherein the mutual capacitances are formed between the first driving electrodes and the sensing electrodes.

7. The mutual capacitance multi-touch control electrode structure using single layer metal mesh according to claim 6, wherein the mutual capacitances are achieved by comb structures between the first driving electrodes and the sensing electrodes.

8. The mutual capacitance multi-touch control electrode structure using single layer metal mesh according to claim 1, wherein an appearance of each of the mesh units is a rhombus.

9. The mutual capacitance multi-touch control electrode structure using single layer metal mesh according to claim 1, wherein a thickness of the metal conducting mesh layer is in a scale of 0.1 μm.

10. A mutual capacitance multi-touch control electrode structure using single layer metal mesh, comprising: a metal conducting mesh layer; the metal conducting mesh layer comprises a plurality of driving line areas, a plurality of sensing line areas and a plurality of shielding line area; the driving line areas are located at one sides of the shielding line areas, and the sensing line areas are located at the other sides of the shielding line areas; the driving line area, sensing line area and shielding line area respectively comprise a plurality of mesh units, and in each of the areas, the mesh units are mutually electrically connected, and one mesh unit adjacent to another mesh unit in adjacent areas are mutually electrically connected; one mesh unit comprises a plurality of mesh edges and nodes formed by two adjacent and connected mesh edges;
wherein the driving line area comprises: a plurality of first driving electrodes and a plurality of second driving electrodes, and the first driving electrode comprises a plurality of first driving lines, and the second driving electrode comprises a plurality of second driving lines; the sensing line area comprises a plurality of sensing electrodes, and the sensing electrode comprises a plurality of sensing lines; the shielding line area comprises a plurality of shielding lines;
wherein each of the first driving lines, the second driving lines, the sensing lines and the shielding lines is a group consisting of several mesh edges;
wherein electrical isolations among the first driving lines, the second driving lines, the sensing lines and the shielding lines are achieved by micro disconnections among the mesh edges;
wherein distances among the first driving lines, the second driving lines, the sensing lines and the shielding lines which are adjacent are smaller than 100 μm to provide enough meshes for dividing the driving line areas and the sensing line areas and forming the mutual capacitances;
wherein the mutual capacitances are formed between the first driving electrodes and the sensing electrodes;
wherein the mutual capacitances are achieved by comb structures between the first driving electrodes and the sensing electrodes;
wherein an appearance of each of the mesh units is a rhombus;
a thickness of the metal conducting mesh layer is in a scale of 0.1 μm.
